(19) United States
(12) Patent Application Publication
(10) Pub. No.: US 2012/0010074 A1
(43) Pub. Date: Jan. 12, 2012

(54) COMPOSITION COMPRISING SUSPENDED PESTICIDE, SALT AND POLYSACCHARIDE

(76) Inventors: Sebastian Koltzenburg, Dannstadt-Schauernheim (DE); Marta Reinoso Garcia, Dossenheim (DE); Andreas Bauder, Mannheim (DE)

(21) Appl. No.: 13/257,192

(22) PCT Filed: Mar. 12, 2010
(86) PCT No.: PCT/EP2010/053147

§ 371 Date: Sep. 16, 2011

(30) Foreign Application Priority Data
Mar. 19, 2009 (EP) 09155559.9

(51) Int. Cl. A01N 43/56; A01C 1/06; A01P 3/00; A01N 25/12

(52) U.S. Cl. 504/100; 424/405; 514/407

(57) ABSTRACT

The present invention relates to an aqueous composition comprising a) a suspended pesticide which is soluble in water at 20° C. to no more than 10 g/l, b) a salt, and c) a protective colloid, which is a polysaccharide which is substituted by C₃-C₃₂-alkylcarbonyl and/or C₃-C₃₂-alkylcarbamoyl groups. The invention furthermore relates to a process for the preparation of the composition by bringing a) the pesticide, b) a salt, and c) the protective colloid, into contact with one another. Moreover, it relates to a use of salt for slowing down the particle growth in an aqueous composition comprising the suspended pesticide and the protective colloid.

The present invention relates to an aqueous composition comprising a) a suspended pesticide which is soluble in water at 20° C. to no more than 10 g/l, b) a salt, and c) a protective colloid which is a polysaccharide which is substituted by C₃-C₃₂-alkylcarbonyl and/or C₃-C₃₂-alkylcarbamoyl groups. The invention furthermore relates to a process for the preparation of the composition by bringing a) the pesticide, b) a salt, and c) the protective colloid, into contact with one another. Moreover, it relates to a use of salt for slowing down the particle growth in an aqueous composition comprising the suspended pesticide and the protective colloid. The present invention comprises combinations of preferred features with other preferred features.

WO 2003/031043 discloses dispersions comprising a continuous aqueous phase which comprises an electrolyte at a concentration of from 0.1 to 1 mol/l and, as surfactant, a hydrophobe-modified polymeric saccharide which is based on saccharides of the fructan type or of the starch type and which is substituted by hydrophobic units such as alkylcarbamoyl radicals or alkylcarbonyl radicals. The dispersions can be prepared for the pesticide sector.

Mooter et al. (Int. J. Pharmaceutics, 2006, 316, 1-6) disclose the preparation of solid dispersions of the antimycotic itraconazole and Inutec SP1, a hydrophobe-modified inulin.

As a rule, a problem occurring in principle in the formulation and use of pesticides in an aqueous medium is the low water solubility of the former, which frequently amounts to less than 10 g/l and in particular less than 1 g/l at 20° C. Aqueous compositions of these pesticides are therefore heterogeneous systems, the active substance being present as the dispersed phase in a continuous aqueous phase. To stabilize these systems, which are metastable per se, pesticide formulations usually comprise surface-active substances such as emulsifiers and/or dispersants. These bring about firstly a reduction of the surface tension of the aqueous phase and secondly stabilize the pesticide particles by electrostatic and/or steric interactions. Despite the use of surface-active substances, aqueous pesticide formulations are frequently unstable and tend to separate out the active substance, for example by sedimentation. These problems are particularly pronounced when the formulation is stored for a prolonged period at elevated temperature and/or at greatly varying temperature or else around freezing point. This problem is particularly pronounced when the active substance tends to crystallization, for example in the case of active substances which show finite solubility in the aqueous phase and/or the surface-active substance.

A further problem in the formulation of pesticides with a finite, or very low, water solubility is that upon dilution of the active substances to the desired use concentration, a separation, such as sedimentation or creaming of the pesticide, may occur. This not only entails a loss of efficacy, but, in the case of spray mixtures, also the risk of clogging of filter and nozzle systems.

The object of the present invention was to formulate sparingly soluble pesticides which are solid at room temperature in aqueous systems. It was intended that the formulation should not crystallize and not sediment upon prolonged storage. A further object was to provide a suspension of pesticides which are sparingly soluble in water and whose particle size does not increase upon storage, or only a little. Furthermore, it was intended to stabilize the formulation with the aid of an environmentally compatible surface-active compound, so that no damage to the plants can be expected upon application of the pesticides.

The object was achieved by an aqueous composition comprising
a) a suspended pesticide which is soluble in water at 20° C. to no more than 10 g/l,
b) a salt, and
c) a protective colloid which is a polysaccharide which is substituted by C₃-C₃₂-alkylcarbonyl and/or C₃-C₃₂-alkylcarbamoyl groups.

The expression pesticide refers to at least one active substance selected from the group consisting of the fungicides, insecticides, nematicides, herbicides, safeners and/or growth regulators. Preferred pesticides are fungicides, insecticides and herbicides, in particular fungicides. Mixtures of pesticides of two or more of the abovementioned classes may also be used. The skilled worker is familiar with such pesticides, which can be found, for example, in Pesticide Manual, 14th Ed. (2006), The British Crop Protection Council, London. Suitable insecticides are insecticides from the class of the carbamates, organophosphates, organochlorine insecticides, phenylpyrazoles, pyrethroids, neonicotinoids, spinosins, avermectins, milbemycins, juvenile hormone analogs, alkyl halides, organotin compounds, nereistoxin analogs, benzoylureas, diacylhydrazines, METI acaricides, and insecticides such as chloropicrin, pymetrozine, flonicamid, clofentezine, hexythiazox, etoxazole, diafenthiuron, propargite, tetradifon, chlorfenapyr, DNOC, buprofezin, cyromazine, amitraz, hydramethylnon, acequinocyl, fluacrypyrim, rotenon, or their derivatives. Suitable fungicides are fungicides from the classes dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzylcarbamates, carbamates, carboxamides, carboxylic acid amides, chloronitriles, cyanoacetamide oximes, cyanoimidazoles, cyclopropanecarboxamides, dicarboximides, dihydrodioxazines, dinitrophenyl crotonates, dithiocarbamates, dithiolanes, ethylphosphonates, ethylaminothiazolecarboxamides, guanidines, hydroxy-(2-amino-)pyrimidines, hydroxyanilides, imidazoles, imidazolinones, inorganic substances, isobenzofuranones, methoxyacrylates, methoxycarbamates, morpholins, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides from the classes of acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ethers, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

In one embodiment, the pesticide comprises an insecticide; preferably, the pesticide consists of at least one insecticide. In a further embodiment, the pesticide comprises a fungicide; preferably, the pesticide consists of at least one fungicide. Preferred fungicides are pyraclostrobin, and prochloraz, especially pyraclostrobin. In a further embodiment, the pesticide comprises a herbicide; preferably, the pesticide consists of at least one herbicide. In a further embodiment, the pesticide comprises a growth regulator; preferably, the pesticide consists of at least one growth regulator. In a further preferred embodiment, the pesticide comprises at least two, preferably two or three, in particular two, different pesticides.

The pesticide is soluble in water at 20° C. to no more than 10 g/l, preferably to no more than 2 g/l and especially preferably to no more than 0.5 g/l. For example, pyraclostrobin is soluble in water to 1.9 mg/l and prochloraz to 34 mg/l.

The pesticide usually has a melting point of above 30° C., preferably above 40° C. and specifically above 45° C. Pyraclostrobin, for example, has a melting point of 64° C., and prochloraz of 47° C.

The composition according to the invention usually comprises from 0.1 to 70% by weight of pesticide, preferably from 1 to 50% by weight, in particular from 3 to 30% by weight, based on the composition.

The pesticide is present in the composition in suspended form, i.e. in the form of crystalline or amorphous particles which are solid at 20° C. The pesticide is preferably present in the form of amorphous particles. The viscosity of the pesticide particles is at least 1000 mPas, preferably at least 5000 mPas and very especially preferably at least 10 000 mPas. The suspended pesticide will, in most cases, have a particle size distribution with an x₅₀ value of from 0.1 to 10 μm, preferably from 0.2 μm to 5 μm and especially preferably from 0.5 μm to 2 μm. The particle size distribution can be determined by laser light diffraction of an aqueous suspension comprising the particles. In this measuring method, the sample preparation, for example the dilution to the measuring concentration, will depend, inter alia, on the fineness and concentration of the active substances in the suspension sample and on the equipment used (for example Malvern Mastersizer). The procedure must be elaborated for the specific system and is known to the skilled worker.

Salts usually comprise an anion and a cation. Examples of suitable salts are metal salts, ammonium salts, amine salts, quaternary ammonium salts and mixtures of these, in particular metal salts and ammonium salts, specifically metal salts and very specifically alkali metal salts. The cations comprise metal ions of monovalent, divalent, trivalent or tetravalent metals and irons which comprise a nitrogen atom. Typical metal cations comprise ions of lithium, sodium, potassium, magnesium, calcium, barium, chromium, manganese, iron, cobalt, nickel, copper, zinc and aluminum. Typical cations which comprise a nitrogen atom comprise ammonium ions, ions of salts of primary, secondary and tertiary amines such as, for example, monoalkylamines, dialkylamines, trialkylamines and benzyldialkylamines, quaternary ammonium ions and ions of organic nitrogen bases such as, for example, morpholine, piperazine, and heterocyclic compounds such as, for example, pyridine. Preferred cations comprise ions of sodium, potassium, magnesium, calcium, iron, copper, zinc, aluminum and ammonium ions, especially preferably sodium and potassium, in particular potassium. The anions comprise hydroxyl anions and anions which are derived not only from inorganic acids, but also from organic acids, such as, for example, hydrogen halides including hydrofluoric acid, hydrochloric acid, hydrobromic acid and hydroiodic acid, sulfuric acid, phosphoric acid, carbonic acid, formic acid, acetic acid and lactic acid. Preferred anions are chloride, sulfate, hydrogen sulfate, phosphate, hydrogen phosphate, dihydrogen phosphate, carbonate, hydrogen carbonate, formate and acetate, especially preferably chloride, sulfate, hydrogen sulfate, phosphate, hydrogen phosphate, dihydrogen phosphate, in particular hydrogen phosphate. Preferred salts are sodium chloride, lithium chloride, ammonium formate, ammonium chloride, lithium formate, dipotassium hydrogen phosphate, potassium dihydrogen phosphate, sodium dihydrogen phosphate, disodium hydrogen phosphate, especially preferably dipotassium hydrogen phosphate (DKHP).

The composition according to the invention will, in most cases, comprise 10% by weight of salt, preferably at least 15% by weight, especially preferably at least 20% by weight and in particular at least 25% by weight, based on the composition.

The upper limit of the salt content is determined by the solubility of the salt in the composition. In most cases, the composition according to the invention will comprise no more salt than the maximum amount which is soluble in the composition. Preferably, the composition comprises no more than 60% by weight of salt, especially preferably no more than 50% by weight, especially preferably no more than 40% by weight. Usually, the salt is present in dissolved form in the composition.

A suitable protective colloid which is a polysaccharide which is substituted by C₃-C₃₂-alkylcarbonyl and/or C₃-C₃₂-alkylcarbamoyl groups will, in most cases, be based on homodisperse or polydisperse, linear or branched polysaccharides. Suitable polysaccharides are fructans, modified starches and starch hydrolysates. Preferred polysaccharides are inulin and starch hydrolysates. Preferably, the protective colloid is a polysaccharide substituted by C₆-C₁₈-alkylcarbonyl and/or C₅-C₁₈-alkylcarbamoyl groups.

Examples of fructans are inulin, oligofructose, fructooligosaccharide, partially hydrolyzed inulin, levan and partially hydrolyzed levan, preferably inulin and partially hydrolyzed inulin. Inulin is a fructan which is composed of molecules which consist predominantly of fructosyl units which are linked to each other via β(2-1)-fructosyl-fructosyl bonds and which may have a terminal glucosyl unit. It is synthesized by certain bacteria and by various plants as a storage carbohydrate and can also be obtained synthetically in an enzymatic method from sugar species which comprise fructose units, for example sucrose. An inulin which is well suited is a polydisperse, linear inulin or moderately branched inulin of vegetable origin with a degree of polymerization (DP) in the range of from three to approximately 100. Usually, inulin has one branch which amounts to less than 20%, preferably less than 10%. An inulin which is especially well suited is chicory inulin with a DP in the range of from three to approximately 70 and a mean DP of 10. More suitable is chicory inulin which has been treated in order to remove most of the monomeric and dimeric saccharide by-products and which has optionally also been treated to remove inulin molecules with a lower DP, usually a DP of from three to nine. These grades of chicory inulin can be obtained from chicory roots by means of conventional extraction, purification and fractionation methods.

Further suitable fructans comprise partially hydrolyzed inulin and inulin molecules with a DP in the range of from three to approximately nine, viz. oligofructose and fructo-oligosaccharides (i.e. oligofructose molecules with an additional terminal glucosyl unit). Products which are usually suitable are obtained by partial enzymatic hydrolysis of chicory inulin.

Further suitable fructans are levan and partially hydrolyzed levan, molecules which consist predominantly of fructosyl units which are linked with each other by β(2-6)fructosyl-fructosyl bonds and which may have a terminal glucosyl unit.

Further suitable polysaccharides are modified starch and starch hydrolysate, in particular starch hydrolysate. In starch, the glucosyl units are usually linked via α-1,4-glucosylglucosyl bonds which form linear molecules referred to as amylose, or via α-1,4- and α-1,6-glucosyl-glucosyl bonds which form branched molecules, referred to as amylopectin. The bonds between the glucosyl units in starch can be cleaved chemically. This phenomenon is exploited industrially for preparing modified starches and starch hydrolysates by means of heat treatment of starch, frequently in the presence of a catalyst, by acid hydrolysis, enzymatic hydrolysis or by shearing, or by combinations of such treatments.

Starch hydrolysates usually refer to polydisperse mixtures which are composed of D-glucose, oligomeric (DP two to ten) and/or polymeric (DP>ten) molecules consisting of D-glycosyl chains. Starch hydrolysates are usually defined via their DE value (dextrose equivalents). Starch hydrolysates can extend from a product which essentially consists of glucose via products with a DE greater than 20 (frequently referred to as glucose syrups) to a DE of 20 or less (frequently referred to as maltodextrins). Starch hydrolysates which are well suited are those with a DE in the range of from two to 47. They can be obtained by traditional methods starting from a variety of starch sources such as, for example, maize, potato, tapioca, rice, sorghum and wheat.

The polysaccharides are substituted by C₃-C₃₂-alkylcarbonyl and/or C₃-C₃₂-alkylcarbamoyl groups, preferably by at least two of these groups. Preferably, the polysaccharides are substituted by C₆-C₁₈-alkylcarbonyl or C₆-C₁₈-alkylcarbamoyl groups. The chemical structures of the alkylcarbonyl group (1) and of the alkylcarbamoyl group (2) are as follows, where “*” represents the bond to a former OH group of the polysaccharide:

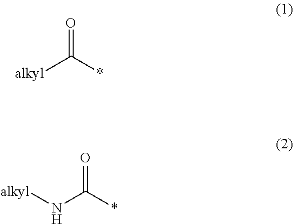

In this context, alkyl means a linear or branched, saturated or unsaturated aliphatic radical with three to 32, preferably four to 20, especially preferably 6 to 14 and specifically 8 to 12 carbon atoms. Preferably, alkyl is a saturated linear aliphatic radical.

The substituted polysaccharide will in most cases have two, three or four hydroxyl groups per saccharide unit, whose hydrogen atom may be substituted by a C₃-C₃₂-alkylcarbonyl and/or C₃-C₃₂-alkylcarbamoyl group. The number of substituted groups per unit is often given as the average degree of substitution (DS). The DS of the substituted polysaccharide will in most cases be in the range of from 0.01 to 0.5, preferably from 0.02 to 0.4, even better from 0.05 to 0.35 and ideally from 0.1 to 0.3.

The protective colloid, which is a polysaccharide substituted by C₃-C₃₂-alkylcarbonyl and/or C₃-C₃₂-alkylcarbamoyl groups, usually has a molar mass of at least 1000 g/mol, preferably at least 4000 g/mol. The solubility in water is, in most cases, below 10% by weight, preferably below 5% by weight and especially below 1% by weight, in each case at 20° C.

The polysaccharide which is substituted by C₃-C₃₂-alkylcarbonyl and/or C₃-C₃₂-alkylcarbamoyl groups can be prepared by traditional methods. For example, C₃-C₃₂-alkylcarbamoyl groups can be bonded to the polysaccharide by reaction with an alkyl isocyanate of the formula alkyl-N═C═O (where alkyl has the abovementioned meaning) in an inert solvent, as described for example in WO 99/64549 and WO 01/44303. C₃-C₃₂-alkylcarbonyl groups can be linked to the polysaccharide for example by reaction of the polysaccharide with an anhydride of the formula R—CO—O—CO—R or with an acid chloride of the formula R—CO—Cl (where alkyl has the abovementioned meaning) in a suitable solvent as disclosed in, for example, EP 0 792 888 and EP 0 703 243. The preparation of substituted inulin is described for example by Stevens et al., Biomacromolecules 2001, 2, 1256-1259. The preparation of substituted starch is described by, for example, Fang et al., Carbohydrate Polymers, 2002, 47, 245-252.

In most cases, the composition according to the invention will comprise from 0.001 to 20% by weight, preferably from 0.01 to 8% by weight, especially preferably from 0.01 to 5% by weight of protective colloid c), based on the total amount of the composition.

Usually, the composition according to the invention comprises formulation adjuvants, the choice of the adjuvants usually depending on the specific use form or on the pesticide. Examples of suitable adjuvants are solvents, solid carriers, surface-active substances (such as surfactants, solubilizers, further protective colloids, wetters and stickers), organic and inorganic thickeners, bactericides, antifreeze agents, antifoams, optionally colorants and adhesives (for example for the treatment of seeds).

Suitable surface-active substances (adjuvants, wetters, stickers, dispersants or emulsifiers) are the alkali metal, alkaline earth metal and ammonium salts of aromatic sulfonic acids, for example of lingo- (Borresperse® types, Borregaard, Norway), phenol-, naphthalene-(Morwet® types, Akzo Nobel, USA) and dibutylnaphthalenesulfonic acid (Nekal® types, BASF, Germany), and of fatty acids, alkyl- and alkylarylsulfonates, alkyl sulfates, lauryl ether sulfates and fatty alcohol sulfates, and salts of sulfated hexa-, hepta- and octadecanols and of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl polyglycol ethers, tributylphenyl polyglycol ethers, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors, and proteins, denatured proteins, polysaccharides (for example methylcellulose), hydrophobe-modified starches, polyvinyl alcohol (Mowiol® types, Clariant, Switzerland), polycarboxylates (Sokalan® types, BASF, Germany), polyalkoxylates, polyvinylamine (Lupamin® types, BASF, Germany), polyethyleneimine (Lupasol® types, BASF, Germany), polyvinylpyrrolidone, and their copolymers.

Surfactants which are particularly suitable are anionic, cationic, nonionic and amphoteric surfactants, block polymers and polyelectrolytes. Suitable anionic surfactants are alkali, alkaline earth or ammonium salts of sulfonates, sulfates, phosphates or carboxylates. Examples of sulfonates are alkylarylsulfonates, diphenylsulfonates, alpha-olefin sulfonates, sulfonates of fatty acids and oils, sulfonates of ethoxylated alkylphenols, sulfonates of condensed naphthalenes, sulfonates of dodecyl- and tridecylbenzenes, sulfonates of naphthalenes and alkylnaphthalenes, sulfosuccinates or sulfosuccinamates. Examples of sulfates are sulfates of fatty acids and oils, of ethoxylated alkylphenols, of alcohols, of ethoxylated alcohols, or of fatty acid esters. Examples of phosphates are phosphate esters. Examples of carboxylates are alkyl carboxylates and carboxylated alcohol or alkylphenol ethoxylates.

Suitable nonionic surfactants are alkoxylates, N-alkylated fatty acid amides, amine oxides, esters or sugar-based surfactants. Examples of alkoxylates are compounds such as alcohols, alkylphenols, amines, amides, arylphenols, fatty acids or fatty acid esters which have been alkoxylated. Ethylene oxide and/or propylene oxide may be employed for the alkoxylation, preferably ethylene oxide. Examples of N-alkylated fatty acid amides are fatty acid glucamides or fatty acid alkanolamides. Examples of esters are fatty acid esters, glycerol esters or monoglycerides. Examples of sugar-based surfactants are sorbitans, ethoxylated sorbitans, sucrose and glucose esters or alkylpolyglucosides. Examples of suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide or of the A-B-C type comprising alkanol, polyethylene oxide and polypropylene oxide. Suitable polyelectrolytes are polyacids or polybases. Examples of polyacids are alkali salts of polyacrylic acid. Examples of polybases are polyvinylamines or polyethyleneamines.

The composition according to the invention can comprise from 0.1 to 40% by weight, preferably from 1 to 30 and in particular from 2 to 20% by weight total amount of surface-active substances and surfactants based on the total amount of the composition. The protective colloid which is a polysaccharide substituted by C₃-C₃₂-alkylcarbonyl and/or C₃-C₃₂-alkylcarbamoyl groups is not included in this total amount.

Examples of adjuvants are organically modified polysiloxanes such as BreakThruS 240®; alcohol alkoxylates such as Atplus®245, Atplus®MBA 1303, Plurafac®LF and Lutensol® ON; EO/PO block polymers, for example Pluronic® RPE 2035 and Genapol® B; alcohol ethoxylates, for example Lutensol® XP 80; and sodium dioctylsulfosuccinate, for example Leophen® RA.

Examples of thickeners (i.e. compounds which impart to the composition a modified flow behavior, i.e. high viscosity at rest and low viscosity in motion) are polysaccharides and organic and inorganic layer minerals such as xanthan gum (Kelzan®, CP Kelco), Rhodopol® 23 (Rhodia) or Veegum® (R.T. Vanderbilt) or Attaclay® (Engelhard Corp.).

Bactericides may be added to stabilize the composition. Examples of bactericides are those based on dichlorophen and benzyl alcohol hemiformal (Proxel® from ICI or Acticide® RS from Thor Chemie and Kathon® MK from Rohm & Haas) and isothiazolinone derivatives such as alkylisothiazolinones and benzoisothiazolinones (Acticide® MBS from Thor Chemie).

Examples of suitable antifreeze agents are ethylene glycol, propylene glycol, urea and glycerol.

Examples of antifoams are silicone emulsions (such as, for example Silikon® SRE, Wacker, Germany or Rhodorsil®, Rhodia, France), long-chain alcohols, fatty acids, salts of fatty acids, organofluorine compounds and their mixtures.

Examples of colorants are both pigments, which are sparingly soluble in water, and dyes, which are soluble in water. Examples which may be mentioned are the dyes and pigments known by the names Rhodamin B, C. I. Pigment Red 112 and C. I. Solvent Red 1, Pigment Blue 15:4, Pigment Blue 15:3, Pigment Blue 15:2, Pigment Blue 15:1, Pigment Blue 80, Pigment Yellow 1, Pigment Yellow 13, Pigment Red 48:2, Pigment Red 48:1, Pigment Red 57:1, Pigment Red 53:1, Pigment Orange 43, Pigment Orange 34, Pigment Orange 5, Pigment Green 36, Pigment Green 7, Pigment White 6, Pigment Brown 25, Basic Violet 10, Basic Violet 49, Acid Red 51, Acid Red 52, Acid Red 14, Acid Blue 9, Acid Yellow 23, Basic Red 10, Basic Red 108.

Examples of stickers are polyvinylpyrrolidone, polyvinyl acetate, polyvinyl alcohol and cellulose ethers (Tylose®, Shin-Etsu, Japan).

In most cases, the composition according to the invention is diluted prior to use in order to prepare what is known as the tank mix. Substances which are suitable for the dilution are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone or water. It is preferred to use water. The diluted composition is usually applied by spraying or atomizing. Immediately before use (tank mix), oils of various types, wetters, adjuvants, herbicides, bactericides, fungicides may be added to the tank mix. These agents can be admixed with the compositions according to the invention in the weight ratio 1:100 to 100:1, preferably 1:10 to 10:1. The pesticide concentration in the tank mix can be varied in substantial ranges. In general, it is between 0.0001 and 10%, preferably between 0.01 and 1%. When used in plant protection, the application rates are between 0.01 and 2.0 kg of active substance per ha, depending on the nature of the desired effect.

The present invention also relates to the use of a composition according to the invention for controlling phytopathogenic fungi and/or undesired plant growth and/or undesired attack by insects or mites and/or for regulating the growth of plants, where the composition is allowed to act on the respective pests, their environment or the plants to be protected from the respective pests, on the soil and/or undesired plants and/or the useful plants and/or their environment. The invention furthermore relates to the use of a composition according to the invention for controlling undesired attack by insects or mites on plants and/or for controlling phytopathogenic fungi and/or for controlling undesired plant growth, where seeds of useful plants are treated with the composition.

Furthermore, the invention relates to seed which has been treated with a composition according to the invention. The seed preferably comprises the composition according to the invention. This composition can be applied to the seed in undiluted or, preferably, diluted form. Here, the composition in question can be diluted by a factor of 2 to 10, so that from 0.01 to 60% by weight, preferably from 0.1 to 40% by weight, of pesticide are present in the compositions to be used for dressing the seed. The application can take place before sowing. The treatment of plant propagation material, in particular the treatment of seed, is known to the skilled worker and is carried out by dusting, coating, pelleting, dipping or soaking the plant propagation material, the treatment preferably being effected by pelleting, coating and dusting, so that, for example, premature germination of the seed is prevented. In the treatment of seed, one will generally use pesticide amounts of from 1 to 1000 g/100 kg, preferably from 5 to 100 g/100 kg propagation material or seed.

The invention also relates to a use of salt for slowing down the particle growth in an aqueous composition comprising a suspended pesticide which is soluble in water at 20° C. to no more than 10 g/l and a protective colloid which is a polysaccharide which is substituted by C₃-C₃₂-alkylcarbonyl and/or C₃-C₃₂-alkylcarbamoyl groups. In most cases, the aqueous phase comprises at least 10% by weight of salt based on the composition. Preferred salts and preferred amounts of salt addition are as described above. Preferred protective colloids are as described above. Usually, the particle growth is slowed down in comparison with a salt-free composition.

The invention also relates to a process for the preparation of a composition according to the invention by bringing
a) a pesticide which is soluble in water at 20° C. to no more than 10 g/l,
b) a salt, and
c) a protective colloid, which is a polysaccharide which is substituted by C₃-C₃₂-alkylcarbonyl and/or C₃-C₃₂-alkylcarbamoyl groups into contact with each other.

The dispersed pesticide a) can be brought into contact with components b) and c) in an aqueous system, or the dispersion may be effected in an aqueous system after the bringing-into-contact of components a), b) and c). The skilled worker is generally familiar with a wide range of processes for dispersing pesticides. Examples of suitable processes are precipitation methods, evaporation methods, melt emulsification or grinding methods, preferably precipitation methods and melt emulsification. The preparation process leads to a composition according to the invention in which the pesticide is present in suspended form. During the melt emulsification, the pesticide may briefly be present in the form of an emulsion of the molten pesticide, the pesticide, however, rapidly solidifying by cooling to be in suspended form.

The process according to the invention preferably comprises a precipitation of the pesticide (precipitation process) or a solidification of an emulsified melt of the pesticide (melt emulsification).

The precipitation process usually comprises the steps
1) dissolving the pesticide in a water-miscible organic solvent or in a mixture of water and a water-miscible organic solvent;
2) mixing, preferably turbulent mixing, of the solution obtained in 1) with an aqueous composition comprising the salt b) and the protective colloid c), a disperse phase comprising pesticide being generated by precipitation; and optionally
3) removing the solvents used in 1) and 2) and/or concentrating the pesticide suspension formed.

The skilled worker is familiar with generally known processes for turbulent mixing. The process step can be carried out batchwise, for example in a stirred vessel, or continuously. Continuously operating machines and apparatuses for making emulsions are, for example, colloid mills, sprocket dispersers and other embodiments of dynamic mixers, furthermore high-pressure homogenizers, pumps with downstream nozzles, valves, membranes or other narrow slit geometries, static mixers, in-line mixers using the rotorstator principle (Ultra-Turrax, inline dissolver), micro-mixing systems and ultrasonic emulsifiers. It is preferred to employ sprocket dispersers or high-pressure homogenizers.

In the present context, the expression “water-miscible organic solvent” means that the organic solvents are miscible with water at 20° C. without phase separation for at least up to 10% by weight, preferably up to 15% by weight, especially preferably up to 20% by weight. The solution can optionally comprise further formulation auxiliaries, for example dispersants. If required, the solution may be prepared at elevated temperature.

Suitable solvents are C₁-C₆-alkyl alcohols such as methanol, ethanol, propanol, isopropanol, 1-butanol, 2-butanol, tert-butanol, esters, ketones such as acetone, methyl ethyl ketone, methyl isopropyl ketone, methyl isobutyl ketone, acetals, ethers, cyclic ethers such as tetrahydrofuran, aliphatic carboxylic acids such as formic acid, acetic acid, propionic acid, N-substituted or N,N-disubstituted carboxamides such as acetamide, carboxylic esters such as, for example, ethyl acetate and lactones such as, for example, butyrolactone, dimethylformamide (DMF) and dimethylpropionamide, aliphatic and aromatic chlorohydrocarbons such as methylene chloride, chloroform, 1,2-dichloroethane or chlorobenzene, N-lactams, glycols such as ethylene glycol or propylene glycol, and mixtures of abovementioned solvents. Preferred solvents are glycols, methanol, ethanol, isopropanol, dimethylformamide, N-methylpyrrolidone, methylene chloride, chloroform, 1,2-dichloroethane, chlorobenzene, acetone, methyl ethyl ketone, methyl isopropyl ketone, methyl isobutyl ketone, tetrahydrofuran and mixtures of abovementioned solvents. Especially preferred solvents are propylene glycol, methanol, ethanol, isopropanol, dimethylformamide and tetrahydrofuran, in particular propylene glycol.

In step 1), the pesticide will in most cases be dissolved in a water-miscible organic solvent at temperatures greater than 30° C., preferably between 50° C. and 240° C., in particular 100° C. to 200° C., especially preferably 140° C. to 180° C., optionally under pressure.

In step 2), the resulting molecular-disperse solution is subsequently treated directly with the optionally cooled, aqueous molecular-disperse or colloid-disperse solution comprising salt b) and protective colloid c), the solvent component of step 1) being introduced into the aqueous phase and the hydrophobic phase of the pesticide originating as the disperse phase. Preferably, a mixing temperature of approximately from 35° C. to 80° C. will be established in step 2).

In process step c), the organic solvents used are optionally removed, and the pesticide suspension formed is concentrated to the desired pesticide content by removing excess water.

Optionally, further formulation auxiliaries can be added before, during or after process steps 1), 2) and 3).

The melt emulsification usually comprises a solidification of an emulsified melt of the pesticide. Preferably, a melt comprising the molten pesticide is emulsified in an aqueous solution and the product is cooled to below the solidification point. In a preferred embodiment, the melt can be emulsified in an aqueous solution by melting the pesticide and introducing this melt into the aqueous solution, preferably while supplying energy. In a further preferred embodiment, the melt can be emulsified in an aqueous solution by melting the pesticide directly in an aqueous solution, while providing energy.

For example, energy can be provided by shaking, stirring, turbulent mixing, injecting of one fluid into another, oscillations and cavitation of the mixture (for example using ultrasound), emulsifying centrifuges, colloid mills, sprocket dispersers or high-pressure homogenizers. In general the temperature differential between melt and aqueous phase is from 0 to 200° C. if the pesticide is first molten and then emulsified in the aqueous phase. Preferably, the melt is from 20 to 200° C. warmer than the aqueous phase. Under certain circumstances, these processes must be carried out in pressurized apparatuses since the vapor pressure of the continuous phase rises as a result of the increase in temperature, and may also be above the ambient pressure. Both the continuous phase comprising the aqueous solution and the disperse phase comprising the molten pesticide can be treated with the adjuvants required accordingly for the formulation and the later use, such as surfactants.

Once the continuous phase comprising the aqueous solution and the disperse phase comprising the molten pesticide have been combined with one another and preemulsified to give a coarse dispersion, the product is said to be a crude emulsion. The crude emulsion can then be treated in an emulsifier, where the droplets of the disperse phase are divided finely (so-called fine emulsification). The fine emulsification process step can be carried out batchwise, for example in a stirred vessel, or continuously. Continuously operating machines and apparatuses for making emulsions are known to the skilled worker. Examples are colloid mills, sprocket dispersers and other embodiments of dynamic mixers, furthermore high-pressure homogenizers, pumps with downstream nozzles, valves, membranes or other narrow slit geometries, static mixers, in-line mixers using the rotor-stator principle (Ultra-Turrax, inline dissolver), micro-mixing systems and ultrasonic emulsifiers. It is preferred to employ sprocket dispersers or high-pressure homogenizers. After the fine emulsification, the fine emulsion can be cooled to below the melting point or melting range of the pesticide. This step can be carried out by cooling with stirring (batch operation) or by passing the fine emulsion through a heat exchanger (continuous operation). During this process, the pesticide in the disperse phase solidifies in particulate form, preferably in particulate amorphous form. Preferably, the melt which has been introduced into an aqueous solution is cooled at a cooling rate of at least 0.5 K/min with the aid of a controllable cooling apparatus. A controllable cooling apparatus comprises, for example, a tube which is capable of being cooled and through which the substances to be cooled flow. In this manner, the cooling rate can be regulated by the flow rate and/or the temperature of the cooled tube. Cooling is generally performed down to below the melting point of the crystalline form of the pesticide, preferably down to less than 50° C., especially preferably down to less than 30° C.

In general, the melt emulsification leads to an aqueous suspension comprising at least 5% by weight, preferably at least 15% by weight and especially preferably at least 20% by weight of particles which comprise the agrochemical active substances preferably in amorphous form, in each case based on the aqueous suspension.

Further formulation auxiliaries may optionally be added to the melt, to the aqueous solution or to the aqueous suspension of the particles. Formulation auxiliaries are, for example, solvents, surfactants, inorganic emulsifiers (so-called Pickering emulsifiers), antifoams, thickeners, antifreeze agents and bactericides. Formulations intended for seed-dressing can additionally also comprise adhesives and optionally pigments.

Advantages of the present invention are inter alia that it makes possible a high loading of a composition with sparingly-soluble pesticide while being stable. The composition and the composition which has been diluted with water show little tendency to crystallization and/or sedimentation, or none at all, even upon prolonged storage. Compositions in the form of suspension concentrates, in particular, are stable and show no tendency to crystallization. The particle size of the suspended pesticide does not increase upon storage, or only little. In particular, the Ostwald ripening is largely suppressed by the present invention. The formulation auxiliaries employed are based on polysaccharides which, as experience has shown, are highly compatible with the treated plants. DKHP, in particular, is an advantageous salt due to its high water solubility, low toxicity and great reduction of the water-solubility of organic substances.

The examples which follow illustrate the invention without limiting it.

### EXAMPLES

Inutec® SP1: A pulverulent lauryl-carbamate-substituted chicory inulin which has been prepared by reacting an isocyanate with inulin in the presence of a basic catalyst (commercially available from Beneo-Orafti, Ghent or NRC Nordmann, Rassmann) with a solubility in water at 20° C. of <1% by weight, a mean molar mass of >4500 g/mol, a content of at least 95% by weight and a pH in water of 5.0-8.0 (as a 5% by weight strength solution).

### Example 1

### Preparation of a Pesticide Suspension by Melt Emulsification

10% pyraclostrobin

1% Inutec® SP 1

30% dipotassium hydrogen phosphate (DKHP)

59% fully demineralized water

The dipotassium hydrogen phosphate was dissolved in water at room temperature. Then, the Inutec® SP 1 was added to the salt solution and incorporated thoroughly with an Ultraturrax T25 to give a dispersion. The salt solution and the pyraclostrobin were heated separately from one another to approximately 80 to 85° C. The molten active substance was added to the aqueous solution and predispersed coarsely with the aid of an Ultraturrax T25. The fine dispersion of the active substance into the aqueous solution was carried out using a high-pressure homogenizer at a dispersing pressure of 2000 bar and a product temperature of from 80 to 85° C. Thereafter, the sample was cooled rapidly to room temperature in ice-water.

The characteristic parameters of the particle size distribution (the cumulative volume distribution x₁₀, x₅₀ and x₉₀, measured with a Malvern Mastersizer 2000 after dilution) were determined immediately after the preparation (“start”) and after 6 months of undisturbed storage at room temperature (table 1).

TABLE 1
Particle size distribution

| | | After 6 |
|---|---|---|
| | Start | months |
| x10 | 0.49 | 0.75 |
| x50 | 1.03 | 1.56 |
| x90 | 2.30 | 3.28 |

### Example 2

### Preparation of a Pesticide Suspension by Melt Emulsification

25% pyraclostrobin

2,5% Inutec® SP 1

30% dipotassium hydrogen phosphate (DKHP)

42.5% fully demineralized water

A dispersion was prepared as described in example 1. The characteristic parameters of the particle size distribution (the cumulative volume distribution, measured with a Malvern Mastersizer 2000 after dilution) were determined immediately after the preparation (“start”) and after 46 days of undisturbed storage at room temperature (table 2).

TABLE 2
Particle size distribution

| | Start | After 46 days |
|---|---|---|
| x10 | 0.36 | 0.45 |
| x50 | 0.84 | 0.99 |
| x90 | 1.92 | 2.16 |

### Comparative Example 1

### Melt Emulsification with Surfactants Not According to the Invention

10% pyraclostrobin

1.5% SDS (sodium lauryl sulfate)

1.5% Pluronic PE 10500

87% water

A dispersion was prepared as described in example 1. The characteristic parameters of the particle size distribution (the cumulative volume distribution, measured with a Malvern Mastersizer 2000 after dilution) were determined immediately after the preparation (“start”) and after 17 hours of undisturbed storage at room temperature (table 3). After 17 h, coarse crystals were clearly discernible when viewed under the light microscope.

TABLE 3
Particle size distribution

| | Start | After 17 h |
|---|---|---|
| x10 | 0.81 | 61.17 |
| x50 | 1.42 | 116.45 |
| x90 | 2.38 | 218.29 |

### Comparative Example 2

### Melt Emulsification Without Addition of Salt

10% pyraclostrobin

1% Inutec SP 1

89% fully demineralized water

A dispersion was prepared as described in example 1. The characteristic parameters of the particle size distribution (the cumulative volume distribution, measured with a Malvern Mastersizer 2000 after dilution) were determined immediately after the preparation (“start”) as x50=1.42 μm and after 72 hours undisturbed storage at room temperature at x50=2.14 μm.

### Course of the Particle Growth Over Time

Table 4 shows the course of the particle growth over time, determined in each case as described above on a sample of example 1 and comparative examples 1 and 2.

TABLE 4
Course of the particle size over time x50 (data in μm)

| | | Comparative | Comparative |
|---|---|---|---|
| Time [h] | Example 1 | example 1 | example 2 |
| 0 | 1.033 | 1.081 | 1.039 |
| 1 | — | 1.53 | 1.171 |
| 2 | — | — | 1.171 |
| 3 | — | 1.91 | — |
| 4 | — | 2.056 | 1.269 |
| 5 | — | 2.253 | — |
| 6 | — | — | 1.348 |
| 24 | — | 265.5 | 1.743 |
| 48 | 0.992 | — | 1.904 |
| 72 | — | — | 2.141 |
| 120 | 1.081 | — | — |
| 168 | 1.153 | — | — |
| 504 | 1.246 | — | — |

### Example 3

### Preparation of a C₁₂-Alkylcarbonyl-Substituted Starch Hydrolysate

With stirring, 162.1 g (1.0 mol) of starch hydrolysate were added to 480 ml of N,N-dimethylacetamide and the mixture was heated to 80° C. so that a solution formed. At 40° C., 8.1 g (0.19 mol) of lithium chloride were added, and the mixture was warmed for 10 min at 80° C. and then left to cool again to 40° C. At this point in time, 24.2 g (0.30 mol) of pyridine were added within 5 minutes, and thereafter 68.1 g (0.30 mol) of lauroyl chloride were added dropwise in the course of 15 minutes. The batch was warmed for 2 h at 80° C., with stirring, and then cooled to room temperature. For work-up, 1450 g of methanol and 620 g of water were weighed into a glass beaker, and the mixture was added slowly with stirring. After 2 hours, a lump had formed which was dried in vacuo at 40° C. and then ground. The meal was heated in 300 ml of toluene to approximately 105° C., with stirring. Upon cooling, approximately 600 ml of acetone were added to cause precipitation. The precipitate was filtered off, dried in vacuo at 40° C. and then ground. This gave 91.7 g of product (conversion rate 44.3%).

### Example 4

### Preparation of a Pesticide Dispersion by Micronization

A salt solution consisting of from 0.5 to 2 g of polysaccharide (Inutec® SP1 or acetylated starch of example 3), 500 g of salt (DKHP or CaCl₂) and 1000 g of water was prepared. Furthermore, 16.0 g of pyraclostrobin and 144 g of propylene glycol were weighed into a 250 ml glass bottle and 100 ml of glass beads (diameter 3 mm) were added. The mixture was suspended for 60 min in a shaker. The resulting, still coarsely particulate suspension was fed, at a flow rate of 1 kg/h, to a dissolution cell via a mixing nozzle, where propylene glycol was added at a temperature of 200° C. at a throughput rate of 2 kg/h. In the dissolution cell, the two streams were mixed turbulently, and a pyraclostrobin solution was generated.

The resulting pyraclostrobin solution was fed to a second mixing nozzle and mixed turbulently with the prepared salt solution at a throughput rate of 16 kg/h. Prior to being fed in, the salt solution was cooled to 5° C. in a cryostat. Upon mixing, the formation of pyraclostrobin particles takes place. The resulting amorphous pyraclostrobin precipitate was discharged. This gave an aqueous dispersion of 0.36% by weight of amorphous pyraclostrobin which comprised 10.0% by weight of the respective polysaccharide based on the amount of pyraclostrobin, or 0.036% by weight based on the total composition (respective composition, see table 5). The particle sizes were determined over 24 h by means of laser diffraction (Malvern Mastersizer S) and laser scattering (Brookhaven Instruments Bl90) (table 6).

For comparison purposes, firstly the batch without addition of salt or of polysaccharide was repeated and analyzed and, secondly, the experiment was repeated, without the use of polysaccharide, but with 4 g of sodium dodecyl sulfate (SDS) being added to the mixture of pyraclostrobin and propylene glycol, for comparison purposes. The aqueous suspension thus obtained comprised 0.36% by weight of pyraclostrobin and 0.1% by weight of SDS.

The experiments demonstrated that the formulations according to the invention featured a slowed-down particle growth in comparison with the formulation without salt or with another protective colloid.

TABLE 5
Composition of the batches

| | | | Protective | | |
|---|---|---|---|---|---|
| | Pyraclostrobin | Protective | colloid | | Salt |
| Batch | [% by wt.] | colloid | [% by wt.] | Salt | [% by wt.] |
| A | 0.36 | Inutec ® SP1 | 0.036 | DKHP | 30 |
| B | 0.36 | Inutec ® SP1 | 0.036 | DKHP | 18 |
| C | 0.36 | Inutec ® SP1 | 0.036 | CaCl₂ | 30 |
| D | 0.36 | Ac starch¹ | 0.036 | DKHP | 30 |
| V1² | 0.36 | SDS | 0.1 | DKHP | 30 |
| V2² | 0.36 | Inutec ® SP1 | 0.036 | — | — |
| V3² | 0.36 | SDS | 0.1 | DKHP | 30 |

¹Acetylated starch (preparation see example 3)
²not according to the invention

TABLE 6
Course of the particle size distribution over time (proportion <1 μm, [%])

| [h] | A | B | C | D | V1 | V2 | V3 |
|---|---|---|---|---|---|---|---|
| 0 | 100 | 100 | 100 | 100 | 100 | 100 | 43.4 |
| 1 | 100 | 100 | 99.4 | 100 | 97.6 | 99.5 | 34 |
| 2 | 100 | 99 | 97.9 | 100 | 92.2 | 97.1 | — |
| 3 | 100 | 99 | 97.9 | 100 | 81 | 94.2 | 14.9 |
| 4 | 100 | 98 | 97.7 | — | 74.6 | 91.5 | 10.8 |
| 5 | 100 | 96 | 97.6 | 100 | 69.1 | 89.6 | — |
| 6 | — | 95.4 | 97.4 | 100 | 64.9 | 85.8 | — |
| 7 | — | 95 | 97.6 | 100 | — | — | — |
| 8 | — | 92.6 | 97.5 | — | — | — | — |
| 24 | 100 | — | 63.6 | — | 50 | 41.9 | — |

1-15. (canceled)

16. An aqueous composition comprising
a) a suspended pesticide which is soluble in water at 20° C. to no more than 10 g/l,
b) at least 10% by weight of metal salt from inorganic acids, and
c) a protective colloid which is a polysaccharide which is substituted by one or more groups selected from the group consisting of C₃-C₃₂-alkylcarbonyl and C₃-C₃₂-alkylcarbamoyl groups.

17. The composition according to claim 16, where the suspended pesticide has a particle size distribution with an x₅₀ value of from 0.1 to 10 μm.

18. The composition according to claim 16, where the polysaccharide is a fructan, a modified starch or a starch hydrolysate.

19. The composition according to claim 16, where the protective colloid is a polysaccharide which is substituted by one or more groups selected from the group consisting of C₆-C₁₈-alkylcarbonyl and C₆-C₁₈-alkylcarbamoyl groups.

20. The composition according to claim 16, where the composition comprises from 0.001 to 20% by weight of the protective colloid.

21. The composition according to claim 16, where the salt comprises a hydrogen phosphate as the anion.

22. The composition according to claim 16, where the pesticide is pyraclostrobin.

23. A process for the preparation of a composition according to claim 16, comprising contacting with each other:
a) a pesticide which is soluble in water at 20° C. to no more than 10 g/l,
b) at least 10% by weight of metal salt from inorganic acids, and
c) a protective colloid which is a polysaccharide which is substituted by groups selected from C₃-C₃₂-alkylcarbonyl and C₃-C₃₂-alkylcarbamoyl groups.

24. The process according to claim 23, comprising precipitating the pesticide or solidifiying an emulsified melt of the pesticide.

25. A method of slowing down the particle growth in an aqueous composition, comprising adding salt to a pesticide suspended in a protective colloid, wherein the pesticide is soluble in water at 20° C. to no more than 10 g/l and wherein the protective colloid is a polysaccharide which is substituted by groups selected from C₃-C₃₂-alkylcarbonyl and C₃-C₃₂-alkylcarbamoyl groups.

26. The method according to claim 25, where the aqueous phase comprises at least 10% by weight of salt based on the composition.

27. A method of controlling phytopathogenic fungi and/or undesired plant growth and/or undesired attack by insects or mites and/or for regulating the growth of plants, comprising contacting the composition according to claim 16 with pests, their environment or the plants to be protected from the respective pest, on the soil and/or undesired plants and/or the useful plants and/or their environment.

28. A method of controlling undesired attack by insects or mites on plants and/or for controlling phytopathogenic funghi and/or for controlling undesired plant growth, comprising treating seeds of useful plants with the composition according to claim 16.

29. A seed treated with the composition according to claim 16.
